(19) United States
(12) Patent Application Publication
(10) Pub. No.: US 2006/0184459 A1
(43) Pub. Date: Aug. 17, 2006

(54) Fuzzy bi-clusters on multi-feature data

(75) Inventor: Laxmi P. Parida, Mohegan Lake, NY (US)

Correspondence Address: MICHAEL J. BUCHENHORNER, ESQ;HOLLAND & KNIGHT, 701 BRICKELL AVENUE, MIAMI, FL, 33131, US

(73) Assignee: International Business Machines Corporation

(21) Appl. No.: 11/009,743

(22) Filed: Dec. 10, 2004

(51) Int. Cl. G06F 15/18

(52) U.S. Cl. 706/1

(57) ABSTRACT

A method for discovering a fuzzy bi-cluster is disclosed. The method includes reading a matrix comprising rows and columns and reading at least one input parameter specifying a fuzzy bi-cluster. The method further includes discovering in the matrix at least one fuzzy bi-cluster that was specified and storing the at least one fuzzy bi-cluster that was discovered.

### CROSS-REFERENCE TO RELATED APPLICATIONS

Not Applicable.

### STATEMENT REGARDING FEDERALLY SPONSORED-RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of data mining and more particularly relates to the field of finding bi-clusters in multi-feature data.

### BACKGROUND OF THE INVENTION

A DNA microarray is usually a silicon chip or a nylon membrane, onto which sequences from different genes are immobilized, or attached, at fixed locations, called a spot. The spot is DNA, cDNA, or a fragment of the gene (oligonucleotide) and its location in the array is used to identify the particular DNA sequence. The slide, also called a “DNA chip”, contains thousands of genes and the spots are usually 200 microns or less in size.

One of the fundamental questions of biology is to understand the nature and extent of interactions of genes and gene products. Genetic interactions are vital to understanding cellular metabolism, development of cells and tissues, response of organisms to their environments and also molecular structure and function. Every cell of every living organism contains a repertoire of identical genes, with only a few exceptions. However, not all of the genes are used in each cell and only a fraction of these genes are turned on—it is the subset that is expressed that confers unique properties to each cell type.

For example, liver cells express genes for poison-detoxifying enzymes while pancreas cells express insulin-making genes. To know how cells achieve such specialization, there is a need to identify which genes each type of cell expresses. The active genes are transcribed into messenger RNA (mRNA) molecules that are then translated into the proteins that perform most of the critical functions of cells. Thus, the detection of the mRNA produced by a cell indicate which genes are expressed. Gene expression is a highly complex and tightly regulated process that allows a cell to respond dynamically both to environmental stimuli and to its own changing needs. This mechanism acts both as a trigger (an “on/off” switch) to control which genes are expressed in a cell as well as the extent of expression (a “volume control”) that increases or decreases the level as necessary.

Protein microarrays are also termed “protein chips.” The spots here are that of proteins which are deposited in a manner that preserves their functions: this way, the function of thousands of proteins can be measured simultaneously. The proteome is the cell's array of proteins and the protein chips provide a glimpse into this data. Although one gene may encode one protein, usually proteins are subject to post-translational modifications and these will always missed be by the DNA or RNA profiling. Protein arrays have been demonstrated in protein-protein, protein-enzyme and protein-small molecule interactions.

DNA microarray technology allows us to look at many genes at once and determine which are expressed and to what extent, in a particular cell type. Protein microarrays can be viewed similarly, although recent work is more focused on DNA microarrays. This document focuses on DNA microarrays, although any other microarray could be subject to a similar analysis.

Microarrays usually involve a series of protocols that introduce variability at each step. It is only natural to separate the informatics aspects from understanding this variability in the microarray measurements. Thus, the subject of interpreting the measurements in this emerging microarray technology is far from straightforward and thus this document focuses only on the data that has been appropriately preprocessed.

The problem is that of finding fuzzy bi-clusters in the microarray data which can be viewed as a two-dimensional array of real numbers with no particular significance to horizontal or vertical adjacency. The current literature allows for discovery of fixed patterns where the columns and rows of a matrix (i.e., a bi-cluster) have a specific value. However, the problem of pattern discovery is compounded with the introduction of approximate (i.e., fuzzy) patterns where most columns or rows, but not all, have a specified value. Approximate patterns are more relevant in finding patterns in gene expressions that are characteristic of a disease and are therefore useful for diagnostics.

Therefore, there is a need to overcome problems with the prior art as discussed above, and more particularly a need to make the process of discovering patterns in multi-feature data more efficient.

### SUMMARY OF THE INVENTION

Briefly, according to an embodiment of the invention, a method for discovering a fuzzy bi-cluster is disclosed. The method includes reading a matrix comprising rows and columns and reading at least one input parameter specifying a fuzzy bi-cluster. The method further includes discovering in the matrix at least one fuzzy bi-cluster that was specified and storing the at least one fuzzy bi-cluster that was discovered.

In another embodiment of the present invention, an information processing system for discovering a fuzzy bi-cluster is disclosed. The information processing system includes an interface for receiving a matrix comprising rows and columns, and at least one input parameter specifying a fuzzy bi-cluster. The information processing system includes a processor configured for discovering in the matrix at least one fuzzy bi-cluster that was specified. The information processing system further includes a memory for storing the at least one fuzzy bi-cluster that was discovered.

In yet another embodiment of the present invention, a computer readable medium including computer instructions for discovering a fuzzy bi-cluster is disclosed. The computer instructions includes instructions for reading a matrix comprising rows and columns and reading at least one input parameter specifying a fuzzy bi-cluster. The computer instructions further include instructions for discovering in the at lest one fuzzy bi-cluster that was specified and storing the at least one fuzzy bi-cluster that was discovered.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is a block diagram illustrating the fuzzy bi-cluster discovery process of one embodiment of the present invention.

FIG. 2 is an exemplary input matrix, in one embodiment of the present invention.

FIG. 3 is the input matrix of FIG. 2 including some selected elements.

FIG. 4 is the input matrix of FIG. 2 including some selected elements.

FIG. 5 is an exemplary input matrix including some selected elements representing a discovered fuzzy bi-cluster, in one embodiment of the present invention.

FIG. 6 is a high level block diagram showing an information processing system useful for implementing one embodiment of the present invention.

### DETAILED DESCRIPTION

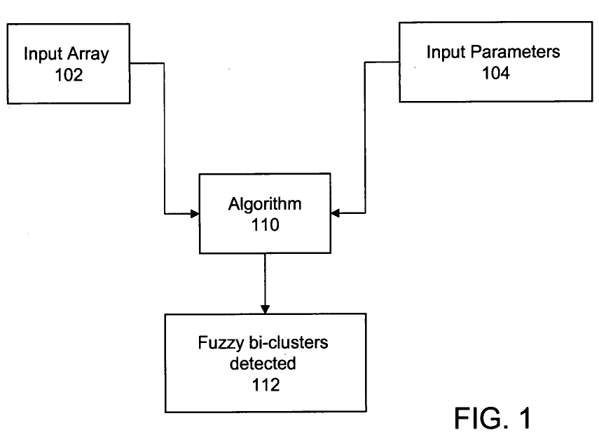

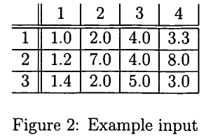

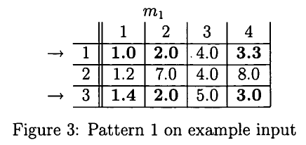

FIG. 1 is a block diagram illustrating the fuzzy bi-cluster discovery process of one embodiment of the present invention. FIG. 1 includes an input array 102, representing a two dimensional matrix of values (i.e., a bi-cluster). FIGS. 2-5 are examples of an input array 102. FIG. 1 also includes input parameters 104, which provide criteria (i.e., a specification or definition) of an approximate fuzzy bi-cluster, which is a two dimensional matrix of values where most columns or rows, but not all, have a specified value, i.e., a fuzzy bi-cluster. Fuzzy bi-clusters are more relevant in gene expressions that are characteristic of a disease and are therefore useful for diagnostics. FIGS. 3-5 include selected (in bold) elements of an input array 102 that qualify as discovered fuzzy bi-clusters. The input array 102 and the input parameters 104 can be a file, such as a text file, or an electronic transmission including the data of the input array 102 or the approximate fuzzy bi-cluster 104.

In an embodiment of the present invention, the input parameters 104 can include one or more defined variables or constants. The values of the input parameter values 104 can be whole numbers or real numbers. For example, the input parameters 104 can include any, or all, of the following defined values. A value k defines the quorum or the minimum number of rows in the fuzzy bi-cluster. A value δ defines a parameter that determines when two real values can be deemed equal (in the instance where the values of the input parameters 104 are real numbers). A value [symbol] defines the fraction of the columns of the input array 102 that can deviate from the bi-cluster value. The input parameter values k and [symbol] can be different for each column in the bi-cluster.

FIG. 1 also includes an algorithm 110 for discovering instances of a fuzzy bi-cluster, as specified by input parameters 104, in the input array 102. The algorithm 110 is described in greater detail below. FIG. 1 further includes a result 112 that includes the instances of the fuzzy bi-cluster, as specified by input parameters 104, that were discovered by the algorithm 110 in the input array 102. The data represented in the result 112 is described in greater detail below. The result 112 can be a file, such as a text file, or an electronic transmission including the data of the result 112.

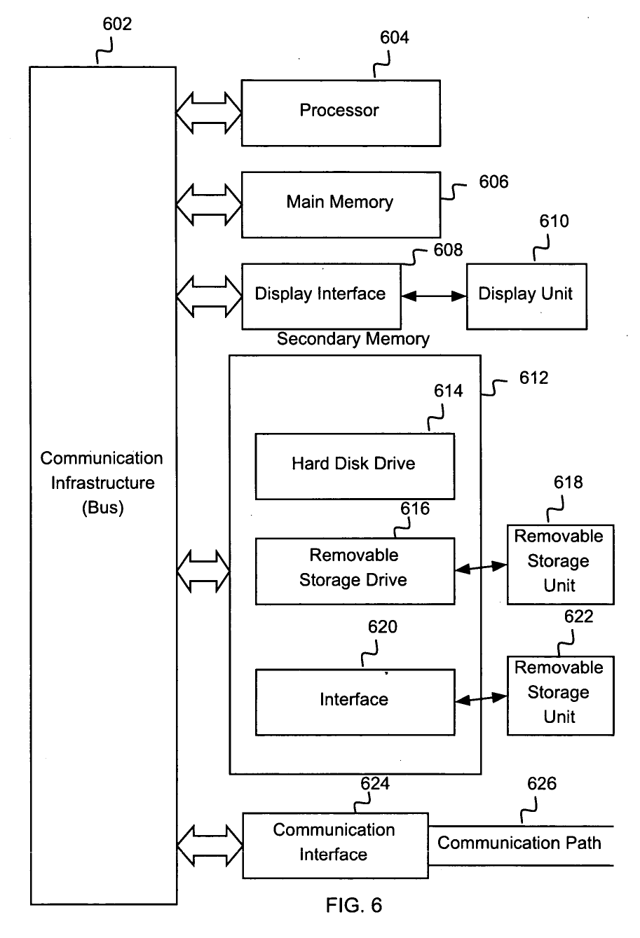

The algorithm 110 can be executed by a computer system. In an embodiment of the present invention, the computer system implementing the features of the present invention is one or more Personal Computers (PCs) (e.g., IBM or compatible PC workstations running the Microsoft Windows operating system, Macintosh computers running the Mac OS operating system, or equivalent), Personal Digital Assistants (PDAs), hand held computers, palm top computers, smart phones, game consoles or any other information processing devices. In another embodiment, the computer system is a server system (e.g., SUN Ultra workstations running the SunOS operating system or IBM RS/6000 workstations and servers running the AIX operating system). Such as computer system is described in greater detail below with reference to FIG. 6.

As explained above, the algorithm 110 discovers instances of a fuzzy bi-cluster, as specified by input parameters 104, in the input array 102. Below is a detailed description of the algorithm 110, wherein the input array 102 is represented by a matrix A and the input parameters 104 include the values δ, k, and [symbol] , as defined more fully above.

Given A, an r×c array of real numbers and a δ>0. A[i,j] denotes the element in row i and column j. Let Rᵢ represent row i, 1≦i≦r and let Cⱼ represent column j, 1≦j≦c. Below are a few definitions.

(x₁≡x₂ given δ>0) Given δ>0 and x₁, x₂εR, x₁≡x₂ holds if |x₁−x₂|≦δ. If x₁ or x₂ is an interval on [symbol] , then x₁≡x₂ holds if x₁∩x₂≠{ }.

(pattern m, size of m, location list [symbol] ₘ) Given A, an r×c array of real numbers, δ>0 and a positive integer k≦r, a pattern m is a collection of columns of the form m={Cⱼ_{₁}=X₁, Cⱼ_{₂}=X₂, . . . Cⱼ=Xₗ} occurs at row Rᵢ if A[i, jₐ]≡Xₐ, 1≦s≦1. Size of m is denoted by |m| is defined to be l. [symbol] ₘ={i|m occurs at row i} and [symbol] ₘ is complete, i.e., if there exists i such that m occurs at i then iε [symbol] ₘ. Also, | [symbol] ₘ≧k holds, i.e., the pattern m occurs at least k times on A.

(m₁ [symbol] m₂) If for each Cⱼ=xεm₁, there exists Cⱼ=x′εm₂ with x1⊂x₂, then m₁ [symbol] m₂ holds.

For example if m₁={C₁=1.2, C₂=3.6, C₃=0.3} and m₂={C₁=1.2, C₃=0.3} then m₂ [symbol] m₁. If m₃={C₃=1.2, C₃=1.3} then m₃ [symbol] m₂ and m₂ [symbol] m₃. Also m₃ [symbol] m₁ and m₁ [symbol] m₃.

(maximal m) A pattern m={Cⱼ_{₁}=x₁, Cⱼ_{₂}=x₂, . . . Cⱼ_{ₛ}=x₁} is maximal if there exists no m′ such that m [symbol] m′ and [symbol] ₘ= [symbol] _{m′}.

Notice that maximality is a notion with respect to all patterns on a given array A. The basic idea is that if all the information about pattern m₁ is already contained in pattern m₂, then m₁ is not of any interest.

Given A, an r×c array of real numbers, δ>0 and a positive integer k≦r, the problem is to find all maximal patterns that occur at least k times on A.

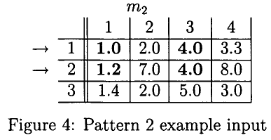

Notice that for any xε [symbol] , for all yε[x−δ, x+δ], x≡y. Consider the example in FIG. 2. Let the input A be as follows with δ=0.5 and k=2. Then m₁={C₁=[0.95, 1.45], C₂=[1.75, 2.25], C₄=[2.9, 3.4]} with [symbol] ₘ_{₁}={1, 3}, m₂={C₁=[0.85, 1.35], C₃=[3.5, 4.5]} with [symbol] ₘ_{₂}={1, 2} are the maximal patterns. Consider a pattern m₃={C₁=[0.95, 1.45], C₂=[1.5, 2.5]} with [symbol] ₘ_{₃}={1, 3}. Notice that m₃ is not maximal and neither is a pattern m₄={C₁=[1.15, 0.95], C₃=[3.75, 4.25]} with [symbol] ₘ_{₄}={1, 2}. m₃ is not maximal with respect to m₁ which has the added component C₄. m₄ is not maximal with respect to m₂ since C₁ interval in m₄ is a contained in the C₁ interval in m₂. These are illustrated in FIGS. 3 and 4.
For a maximal pattern m, each column interval is of the form Cⱼ=[x₁,x₂] where x₂−x₁=δ. Alternatively, the column interval of a maximal pattern is of the form Cⱼ=[x−δ/2, x+δ/2]. Further

$$x = \frac{{\sum }_{i ∈ {L}_{m}} A [ i , j ]}{\vert {L}_{m} \vert}$$

This is straightforward to verify and we omit the formal arguments here.
Following is a natural variation of the pattern on arrays which arises in many practical situations. An approximate pattern defined as follows: (approximate pattern) Given A, an r×c array of real numbers, δ>0 and a positive integer k≦r, and additionally two reals, 0<ε_{c}, ε_{c}≦1, an approximate pattern m is a collection of columns of the form m={Cⱼ_{₁}=X₁, Cⱼ_{₂}=X₂, . . . Cⱼ_{ₛ}=Xₗ} if

1. for each i, A[i,j]≡Xⱼ holds for no less than s(1−ε_{c}) j's.

2. for each j, A[i,j]≡Xⱼ holds for no less than k(1−εᵣ) i's.

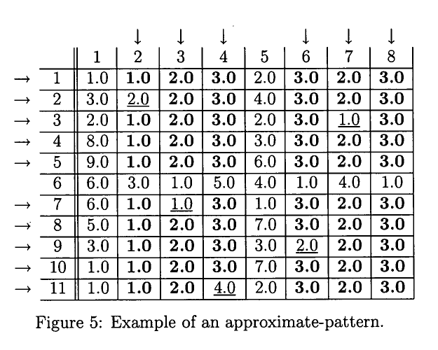

Following is a simple example in FIG. 5 to show that an approximate pattern is an interesting phenomenon in an array. Consider the following input array A with k=8 and δ=0.5. It is natural to expect a pattern as indicated by the arrows on the array. However the underlined values in the array show that they differ from the rest of the pattern. Allowing some error (say εᵣ=ε_{c}=0.05) allows us to bring them in as a single pattern as one expects naturally.

Algorithm:

Given A, an (r×c) array of real numbers, δⱼ>0, 1≦j≦c and a positive integer (quorum) k≦r. Further assume that εᵣ=0 and if m={Cⱼ_{₁}=X₁, Cⱼ_{₂}=X₂, . . . Cⱼ_{ₛ}=Xₗ} and if i∉ [symbol] ₘ, then A[i,j_{J}]≢Xⱼ, 1≦J≦s, then the following algorithm is guaranteed to detect all such approximate patterns.

Initialize:

(1) For each j
Cⱼ⁰←φ, Cⱼ^{l}←{i₁, i₂||A[i₁,j]−A[i₂,j]|≦δⱼ}
   (l is an indexing counter)
For each j the sets are: Cⱼ⁰, Cⱼ¹, Cⱼ², . . . , Cⱼ¹^{ⱼ}

(2) For each j, Ans[j][0]←φ, Ans[j][1]←φ

(3) For each C₁⁻,
R←Ans[j][1]←C₁⁻
Recurse(Ans, R, 1)

Recurse(Ans, R, j)

{

(1) If (j≧c) then output Ans and exit

(2) For each l

(2.1) Ans′←Ans

(2.2) C₀←Cⱼ₊₁^{l}∩R, C₁←R\Cⱼ₊₁^{l}, C₂←Cⱼ₊₁^{l}\R

(2.3) If (C₂=φ) OR

(2.1) for each

$$J \leq j , ( ( \frac{\vert {Ans}^{′} [ J ] [ 1 ] ⋃ {C}_{2} \vert}{\vert ( {Ans}^{′} [ j ] [ 0 ] \neq ϕ ) ⋃ {C}_{2} \vert} ) \leq {δ}_{J} )$$

Ans′[J][1]←Ans′[J][1]∪C₂, R←R∪C₂

(2.2) Ans′[j+1][0]←C₀, Ans′[j+1][1]←(C₁∪C₂)

(2.3) Recurse(Ans′, R, j+1)

(3) Recurse(Ans, R, j+1)

}

Following is a more detailed description of the algorithm described above. The input A is a two dimensional array of real values with r rows and c columns. Also included are the following input parameters 104: value k that defines the quorum or the minimum number of rows in the fuzzy bi-cluster, a value δ that defines a parameter that determines when two real values can be deemed equal, and a value [symbol] that defines the fraction of the columns of the input array 102 that can deviate from the bi-cluster value. The input parameter values k and [symbol] can be different for each column in the bi-cluster.

First, for each column in the input array A, the sets are formed that group the rows in that column using the δ value. This step is annotated as step (1) of the algorithm above. These sets are called Cⱼ₁ where j denotes the column number and l is an index for the collection of sets for that column. For each column, these sets could be overlapping. For example for column 1, Cⱼ₁ could be the set of rows 1, 2 and 3, and Cⱼ₂ could be the set of rows. 3, 4 and 5, with row 3 common to both the sets. The initialization of the result in the matrix Ans is described in step (2) of the algorithm above. In step (3) of the algorithm above, the main method is called, starting with each set computed in step (1).

The main method, Recurse( ), is recursive in nature and helps save the state of the computation in a systematic fashion, thereby adding to its efficiency. Ans is a two dimensional array that stores for each accumulating bi-cluster, the number of rows that satisfy the bi-cluster requirements in Ans[j][1] and number of rows including the ones that deviate from the requirement in Ans[j][0], where j is the column number. The resulting set of rows is accumulated in R of the Recurse( ) routine. For each set C of the next column (step (2) of the Recurse( ) routine), three sets are computed 1) C₀ which is the common rows of the set C and R, 2) C₁ which is the rows of R minus the rows of the new set, and 3) C₂ which is the rows of the new set minus the rows of R (step (2.2) of the Recurse( ) routine).

If the C condition is satisfied, in step (2.1), for each of the preceding columns in R that is stored in the variable Ans[ ][1], then R is updated appropriately with the columns C₂. The method continues to all the other sets of the current column, in step (2.3). In step (3), the method continues by ignoring the current column j. The method terminates when all the columns are processed (see step (1)).

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following: a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer system to read such computer readable information.

FIG. 6 is a high level block diagram showing an information processing system useful for implementing one embodiment of the present invention. The computer system includes one or more processors, such as processor 604. The processor 604 is connected to a communication infrastructure 602 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 608 that forwards graphics, text, and other data from the communication infrastructure 602 (or from a frame buffer not shown) for display on the display unit 610. The computer system also includes a main memory 606, preferably random access memory (RAM), and may also include a secondary memory 612. The secondary memory 612 may include, for example, a hard disk drive 614 and/or a removable storage drive 616, representing a floppy disk drive, a magnetic tape drive, an optical disk drive, etc. The removable storage drive 616 reads from and/or writes to a removable storage unit 618 in a manner well known to those having ordinary skill in the art. Removable storage unit 618, represents a floppy disk, a compact disc, magnetic tape, optical disk, etc. which is read by and written to by removable storage drive 616. As will be appreciated, the removable storage unit 618 includes a computer readable medium having stored therein computer software and/or data.

In alternative embodiments, the secondary memory 612 may include other similar means for allowing computer programs or other instructions to be loaded into the computer system. Such means may include, for example, a removable storage unit 622 and an interface 620. Examples of such may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to the computer system.

The computer system may also include a communications interface 624. Communications interface 624 allows software and data to be transferred between the computer system and external devices. Examples of communications interface 624 may include a modem, a network interface (such as an Ethernet card), a communications port, a PCMCIA slot and card, etc. Software and data transferred via communications interface 624 are in the form of signals which may be, for example, electronic, electromagnetic, optical, or other signals capable of being received by communications interface 624. These signals are provided to communications interface 624 via a communications path (i.e., channel) 626. This channel 626 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 606 and secondary memory 612, removable storage drive 616, a hard disk installed in hard disk drive 614, and signals. These computer program products are means for providing software to the computer system. The computer readable medium allows the computer system to read data, instructions, messages or message packets, and other computer readable information from the computer readable medium.

Computer programs (also called computer control logic) are stored in main memory 606 and/or secondary memory 612. Computer programs may also be received via communications interface 624. Such computer programs, when executed, enable the computer system to perform the features of the present invention as discussed herein. In particular, the computer programs, when executed, enable the processor 604 to perform the features of the computer system. Accordingly, such computer programs represent controllers of the computer system.

What has been shown and discussed is a highly-simplified depiction of a programmable computer apparatus. Those skilled in the art will appreciate that other low-level components and connections are required in any practical application of a computer apparatus.

Therefore, while there has been described what is presently considered to be the preferred embodiment, it will be understood by those skilled in the art that other modifications can be made within the spirit of the invention.

What is claimed is:

1. A method for discovering a fuzzy bi-cluster, the method comprising:
reading a matrix comprising rows and columns;
reading at least one input parameter specifying a fuzzy bi-cluster;
discovering in the matrix at least one fuzzy bi-cluster that was specified; and
storing the at least one fuzzy bi-cluster that was discovered.

2. The method of claim 1, wherein the step of reading a matrix comprises:
reading a matrix comprising whole numbers arranged in rows and columns.

3. The method of claim 2, wherein the step of reading at least one input parameter comprises:
reading at least one input parameter specifying a fuzzy bi-cluster, wherein the at least one input parameter includes any one of:
a value that defines a minimum number of rows in the fuzzy bi-cluster; and
a value that defines a fraction of the columns of the matrix that can deviate from the fuzzy bi-cluster.

4. The method of claim 1, wherein the step of reading a matrix comprises:
reading a matrix comprising real numbers arranged in rows and columns.

5. The method of claim 4, wherein the step of reading at least one input parameter comprises:
reading at least one input parameter specifying a fuzzy bi-cluster, wherein the at least one input parameter includes any one of:
a value that defines a minimum number of rows in the fuzzy bi-cluster;
a value that defines a parameter that determines when two real values are deemed equal; and
a value that defines a fraction of the columns of the matrix that can deviate from the fuzzy bi-cluster.

6. The method of claim 1, wherein the step of storing comprises:
storing the at least one fuzzy bi-cluster that was discovered, wherein an index is stored for each element of the fuzzy bi-cluster that was discovered.

7. A computer readable medium including computer instructions for discovering a fuzzy bi-cluster, the computer instructions including instructions for:
reading a matrix comprising rows and columns;
reading at least one input parameter specifying a fuzzy bi-cluster;
discovering in the matrix at least one fuzzy bi-cluster that was specified; and
storing the at least one fuzzy bi-cluster that was discovered.

8. The computer readable medium of claim 7, wherein the instructions for reading a matrix comprise:
reading a matrix comprising whole numbers arranged in rows and columns.

9. The computer readable medium of claim 8, wherein the instructions for reading at least one input parameter comprise:
reading at least one input parameter specifying a fuzzy bi-cluster, wherein the at least one input parameter includes any one of:
a value that defines a minimum number of rows in the fuzzy bi-cluster; and
a value that defines a fraction of the columns of the matrix that can deviate from the fuzzy bi-cluster.

10. The computer readable medium of claim 7, wherein the instructions for reading a matrix comprise:
reading a matrix comprising real numbers arranged in rows and columns.

11. The computer readable medium of claim 10, wherein the instructions for reading at least one input parameter comprise:
reading at least one input parameter specifying a fuzzy bi-cluster, wherein the at least one input parameter includes any one of:
a value that defines a minimum number of rows in the fuzzy bi-cluster;
a value that defines a parameter that determines when two real values are deemed equal; and
a value that defines a fraction of the columns of the matrix that can deviate from the fuzzy bi-cluster.

12. The computer readable medium of claim 7, wherein the instructions for storing comprise:
storing the at least one fuzzy bi-cluster that was discovered, wherein an index is stored for each element of the fuzzy bi-cluster that was discovered.

13. An information processing system for discovering a fuzzy bi-cluster, comprising:
an interface for receiving a matrix comprising rows and columns, and at least one input parameter specifying a fuzzy bi-cluster;
a processor configured for discovering in the matrix at least one fuzzy bi-cluster that was specified; and
a memory for storing the at least one fuzzy bi-cluster that was discovered.

14. The information processing system of claim 13, wherein the matrix comprises whole numbers.

15. The information processing system of claim 14, wherein the at least one input parameter comprises any one of:
a value that defines a minimum number of rows in the fuzzy bi-cluster; and
a value that defines a fraction of the columns of the matrix that can deviate from the fuzzy bi-cluster.

16. The information processing system of claim 13, wherein the matrix comprises real numbers.

17. The information processing system of claim 16, wherein the at least one input parameter includes any one of:
a value that defines a minimum number of rows in the fuzzy bi-cluster;
a value that defines a parameter that determines when two real, values are deemed equal; and
a value that defines a fraction of the columns of the matrix that can deviate from the fuzzy bi-cluster.

18. The information processing system of claim 13, wherein an index is stored in the memory for each element of the fuzzy bi-cluster that was discovered.
